(19) United States
(12) Patent Application Publication
(10) Pub. No.: US 2025/0259432 A1
(43) Pub. Date: Aug. 14, 2025

(54) VIDEO PROCESSING SYSTEM, VIDEO PROCESSING APPARATUS, AND VIDEO PROCESSING METHOD

(71) Applicant: NEC Corporation, Minato-ku, Tokyo (JP)

(72) Inventors: Florian BEYE, Tokyo (JP); Takanori IWAI, Tokyo (JP); Koichi NIHEI, Tokyo (JP); Hayato ITSUMI, Tokyo (JP); Katsuhiko TAKAHASHI, Tokyo (JP); Yasunori BABAZAKI, Tokyo (JP); Ryuhei ANDO, Tokyo (JP); Jun PIAO, Tokyo (JP)

(73) Assignee: NEC Corporation, Minato-ku, Tokyo (JP)

(21) Appl. No.: 18/857,236

(22) PCT Filed: Sep. 15, 2022
(86) PCT No.: PCT/JP2022/034510

§ 371 Date: Oct. 16, 2024

(51) Int. Cl. G06V 10/82; G06T 7/20

(52) U.S. Cl. CPC G06V 10/82; G06T 7/20

(57) ABSTRACT

An object is to provide a video processing system, a video processing apparatus, and a video processing method that can be expected to improve recognition accuracy of an object in a video. A video processing system includes video acquisition means, time difference information acquisition mean, and recognition means. The video acquisition means acquires an input video. The time difference information acquisition means acquires first time difference information between the frames of the input video. The recognition means inputs the input video and the first time difference information between the frames of the input video to a trained recognition model trained using a training video and second time difference information between frames of the training video and recognizing an object in the input video.

### TECHNICAL FIELD

The present disclosure relates to a video processing system, a video processing apparatus, and a video processing method.

### BACKGROUND ART

Techniques in which videos obtained by imaging edge side terminals are transmitted to center side servers, and the center side servers recognize objects in the videos by AI engines have been developed. For example, the servers recognize types of work performed by workers. Here, the terminals on the edge side change frame rates of the videos by frame filtering or the like for efficient use of calculation resources and efficient use of network bands.

As a related technique, Patent Literature 1 discloses a technique of performing video scene recognition from time-series frames extracted from a video using a deep learning algorithm such as a recurrent neural network (RNN).

### CITATION LIST

### Patent Literature

Patent Literature 1: Japanese Unexamined Patent Application Publication No. 2018-005638

### SUMMARY OF INVENTION

### Technical Problem

In the technique of Patent Literature 1 or the like, since a server on a center side does not support a change in a frame rate of a video, object recognition supporting the change in the frame rate of the video cannot be performed, and thus there is room for improvement in recognition accuracy of an object in the video.

In view of such a problem, an object of the present disclosure is to provide a video processing system, a video processing apparatus, and a video processing method that can be expected to improve recognition accuracy of an object in a video.

### Solution to Problem

According to an aspect of the present disclosure, a video processing system includes:
video acquisition means for acquiring an input video;
time difference information acquisition means for acquiring first time difference information between frames of the input video; and
recognition means for inputting the input video and the first time difference information between the frames of the input video to a trained recognition model trained using a training video and second time difference information between frames of the training video and recognizing an object in the input video.

According to another aspect of the present disclosure, a video processing apparatus includes:
video acquisition means for acquiring an input video;
time difference information acquisition means for acquiring first time difference information between frames of the input video; and
recognition means for inputting the input video and the first time difference information between the frames of the input video to a trained recognition model trained using a training video and second time difference information between frames of the training video and recognizing an object in the input video.

According to still another aspect of the present disclosure, a video processing method includes: by a computer,
acquiring an input video;
acquiring first time difference information between frames of the input video; and
inputting the input video and the first time difference information between the frames of the input video to a trained recognition model trained using a training video and second time difference information between frames of the training video and recognizing an object in the input video.

### Advantageous Effects of Invention

According to the present disclosure, it is possible to provide a video processing system, a video processing apparatus, and a video processing method that can be expected to improve recognition accuracy of an object in a video.

### BRIEF DESCRIPTION OF DRAWINGS

FIG. 1 is a block diagram illustrating a configuration of a video processing system according to an overview of an example embodiment.

FIG. 2 is a block diagram illustrating a configuration of a video processing apparatus according to an overview of an example embodiment.

FIG. 3 is a flowchart illustrating a video processing method according to an overview of the example embodiment.

FIG. 4 is a block diagram illustrating a configuration of a video processing system according to a first example embodiment.

FIG. 5 is a block diagram illustrating a configuration of a terminal according to the first example embodiment.

FIG. 6 is a block diagram illustrating a configuration of a center server according to the first example embodiment.

FIG. 7 is a flowchart illustrating an operation of the video processing system according to the first example embodiment.

FIG. 8 is a diagram illustrating an example of input information of a trained recognition model according to the first example embodiment.

FIG. 9 is a diagram illustrating an example of a configuration of a trained recognition model and a recognition operation according to the first example embodiment.

FIG. 10 is a block diagram illustrating a configuration of a center server according to a second example embodiment.

FIG. 11 is a flowchart illustrating an example of an operation of a video processing system according to the second example embodiment.

FIG. 12 is a diagram illustrating an example of a configuration of a trained recognition model and a recognition operation according to the second example embodiment.

FIG. 13 is a diagram illustrating an example of a first training operation of a recognition model according to the second example embodiment.

FIG. 14 is a diagram illustrating an example of a second training operation of the recognition model according to the second example embodiment.

FIG. 15 is a diagram illustrating another example of the configuration of the trained recognition model and the recognition operation according to the second example embodiment.

FIG. 16 is a block diagram illustrating a configuration of a computer according to the present example embodiment.

### EXAMPLE EMBODIMENT

Hereinafter, example embodiments of the present disclosure will be described in detail with reference to the drawings. In the drawings, the same or corresponding elements are denoted by the same reference numerals and signs, and repeated description of the elements will be omitted to clarify the description as necessary.

### OVERVIEW OF EXAMPLE EMBODIMENT

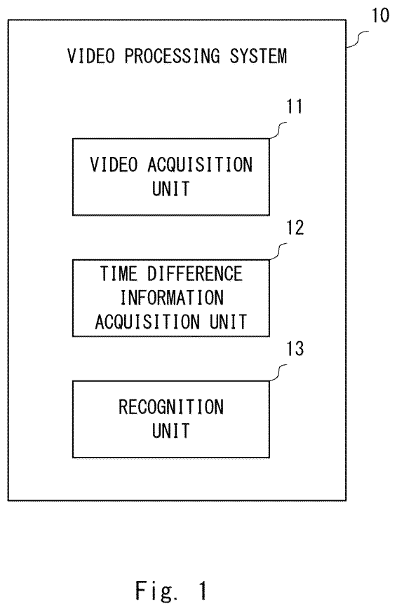

First, a video processing system 10 according to an overview of an example embodiment will be described with reference to FIG. 1. FIG. 1 is a block diagram illustrating a configuration of the video processing system 10 according to an overview of an example embodiment. The video processing system 10 is applicable to, for example, a remote monitoring system that collects videos via a network and recognizes the videos.

As illustrated in FIG. 1, the video processing system 10 includes a video acquisition unit 11, a time difference information acquisition unit 12, and a recognition unit 13. The video acquisition unit 11 acquires an input video. The time difference information acquisition unit 12 acquires first time difference information between frames of the input video. The recognition unit 13 inputs the input video and the first time difference information between the frames of the input video to the trained recognition model trained using the training video and second time difference information between the frames of the training video, and recognizes an object in the input video.

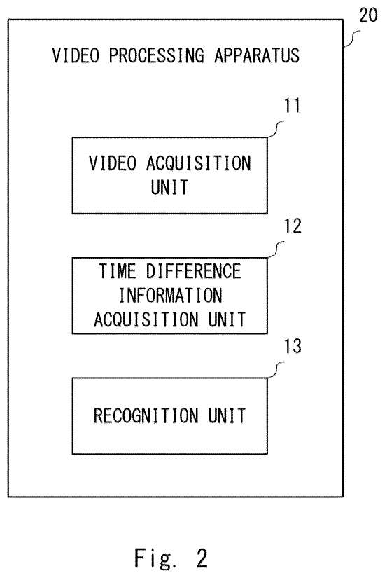

Next, a configuration of the video processing apparatus 20 according to the overview of the example embodiment will be described with reference to FIG. 2. FIG. 2 is a block diagram illustrating a configuration of the video processing apparatus 20 according to the overview of the example embodiment. As illustrated in FIG. 2, the video processing apparatus 20 includes the video acquisition unit 11, the time difference information acquisition unit 12, and the recognition unit 13 illustrated in FIG. 1. When the video processing apparatus 20 is realized by edge computing, a part or all of the video processing apparatus 20 may be disposed on an edge or a cloud. For example, the video acquisition unit 11 and the time difference information acquisition unit 12 may be disposed in a terminal of the edge, and the recognition unit 13 may be disposed in a server of the cloud. Further, functions may be distributed and disposed in the cloud. The video processing apparatus 20 may be realized by a virtualization technique such as a virtualization server. A part or all of the video processing apparatus 20 may be disposed on a site side or a server side. An apparatus disposed at a site where the terminal is installed, an apparatus arranged at a place close to the site, or an apparatus disposed at a network hierarchy close to the terminal is defined as an apparatus disposed at the site side. An apparatus located away from the site is defined as an apparatus disposed on the center side. Since the apparatus disposed on the center side may be disposed on a cloud, the center side may be referred to as a cloud side.

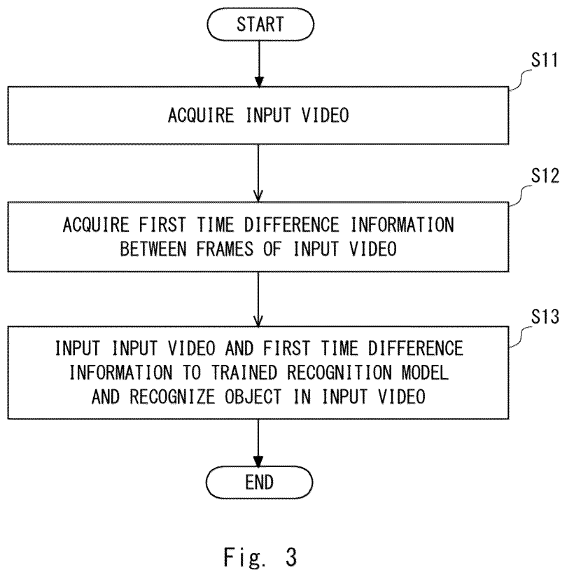

Next, a video processing method according to an overview of the example embodiment will be described with reference to FIG. 3. FIG. 3 is a flowchart illustrating a video processing method according to an overview of the example embodiment. For example, the video processing method according to the example embodiment is performed by the video processing system 10 in FIG. 1 or the video processing apparatus 20 in FIG. 2.

As illustrated in FIG. 3, the input video is acquired (step S11). Next, the first time difference information between the frames of the input video is acquired (step S12). Next, the input video and the first time difference information between the frames of the input video are input to the trained recognition model trained using the training video and the second time difference information between the frames of the training video, and an object in the input video is recognized (step S13).

As described above, the video processing system 10 can recognize the object corresponding to a change in a frame rate of the video by considering the time difference information between the frames of the input video. In the video processing system 10, it can be expected that recognition accuracy of the object in the video will be improved.

### (Basic Configuration of Video Processing System)

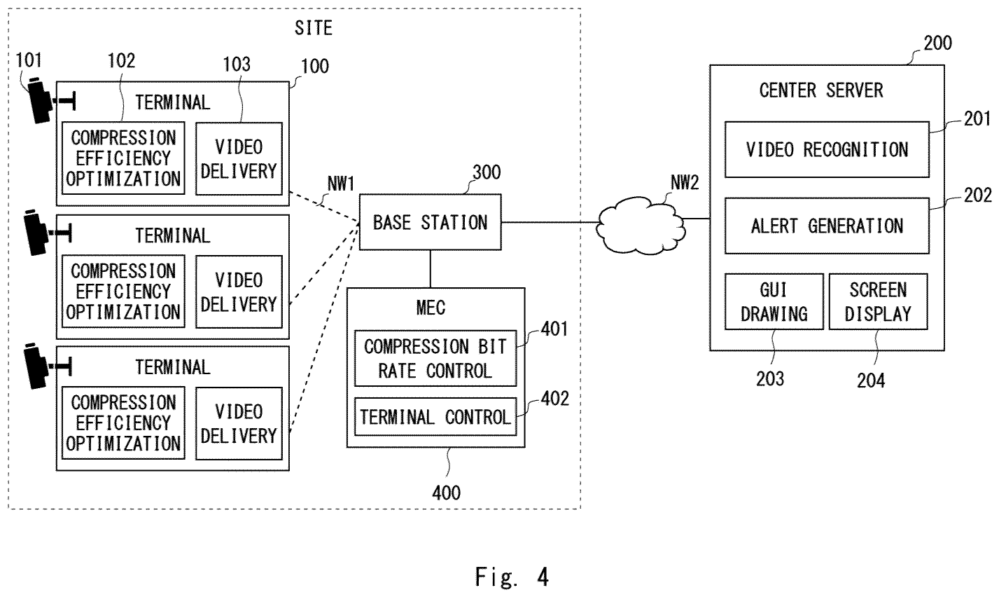

Next, a video processing system 1 which is an example of a system to which the example embodiment is applied will be described with reference to FIG. 4. FIG. 4 is a block diagram illustrating a configuration of the video processing system 1 according to the first example embodiment. As illustrated in FIG. 4, the video processing system 1 is a system that monitors a captured area by a video captured by a camera. Hereinafter, in the present example embodiment, the video processing system 1 will be described below as a system that remotely monitors work of a worker at a site. For example, the site may be an area such as a work site such as a construction site, a square where people gather, or a school where people and machines operate. In the present example embodiment, hereinafter, the work will be described as construction work, civil engineering work, or the like, but the work is not limited thereto. Since the video includes time-series frames that are time-series images, the videos and the images are terms that can be used interchangeably. That is, the video processing system can be said to be a video processing system that processes a video and an image processing system that processes an image.

The video processing system 1 includes a plurality of terminals 100, a center server 200, a base station 300, and a MEC 400. The terminal 100, the base station 300, and the MEC 400 are disposed on the site side, and the center server 200 is disposed on the center side. For example, the center server 200 is disposed in a data center or the like disposed at a position away from the site. The site side is an edge side of the system, and the center side is also a cloud side.

The terminal 100 and the base station 300 are communicatively connected by a network NW1. The network NW1 is, for example, a wireless network such as a 4G, local 5G/5G, long term evolution (LTE), or a wireless LAN network. The base station 300 and the center server 200 are communicatively connected by a network NW2. The network NW2 includes, for example, a core network such as a 5th generation core network (5GC) or an evolved packet core (EPC), the Internet, or the like. It can also be said that the terminal 100 and the center server 200 are communicatively connected via the base station 300. The base station 300 and the MEC 400 are communicatively connected by any communication method, but the base station 300 and the MEC 400 may be one apparatus.

The terminal 100 is a terminal apparatus connected to the network NW1, and is also a video generation apparatus that generates a video of a site. The terminal 100 acquires a video captured by the camera 101 installed at the site, and transmits the acquired video to the center server 200 via the base station 300. The camera 101 may be disposed outside of the terminal 100 or inside the terminal 100.

The terminal 100 compresses a video of the camera 101 at a predetermined bit rate and transmits the compressed video. The terminal 100 has a compression efficiency optimization function 102 of optimizing compression efficiency and a video delivery function 103. The compression efficiency optimization function 102 performs region of interest (ROI) (also referred to as a gaze region) control to control quality of the ROI. The compression efficiency optimization function 102 reduces the bit rate by reducing image quality of a region around the ROI including a person or an object while maintaining the image quality of the ROI. The video delivery function 103 delivers a video of which the image quality is controlled to the center server 200.

The base station 300 is a base station apparatus of the network NW1, and is also a relay apparatus that relays communication between the terminal 100 and the center server 200. For example, the base station 300 is a local 5G base station, a 5G next generation node B (gNB), an LTE evolved node B (eNB), an access point of a wireless LAN, or the like, but may be another relay apparatus.

A multi-access edge computing (MEC) 400 is an edge processing apparatus disposed on an edge side of the system. The MEC 400 is an edge server that controls the terminal 100, and has a compression bit rate control function 401 that control a bit rate of the termina and a terminal control function 402. The compression bit rate control function 401 controls a bit rate of terminal 100 by adaptive video delivery control or quality of experience (QoE) control. For example, the compression bit rate control function 401 predicts the recognition accuracy to be obtained while curbing the bit rate according to a communication environment of the networks NW1 and NW2, and allocates the bit rate to the camera 101 of each terminal 100 so that recognition accuracy is improved. The terminal control function 402 controls the terminal 100 so that a video of the allocated bit rate is delivered. The terminal 100 encodes the video so that the video has the allocated bit rate, and delivers the encoded video.

The center server 200 is a server installed on the center side of the system. The center server 200 may be one or a plurality of physical servers, a cloud server constructed on a cloud, or another virtualization server. The center server 200 is a monitoring apparatus that monitors work of a site by recognizing work of a person from a camera image of the site. The center server 200 is also a video recognition apparatus that recognizes an action or the like of a person in the video transmitted from the terminal 100.

The center server 200 has a video recognition function 201, an alert generation function 202, a GUI drawing function 203, and a screen display function 204. The video recognition function 201 recognizes work performed by the worker, that is, a type of action of the person, by inputting the video transmitted from the terminal 100 to an AI engine (for example, a trained recognition model). The alert generation function 202 generates an alert according to the recognized work. The GUI drawing function 203 displays a graphical user interface (GUI) on a screen of the display apparatus. The screen display function 204 displays a video, a recognition result, an alert, and the like of the terminal 100 on the GUI.

### First Example Embodiment

First, a configuration of a video processing system 1 according to a first example embodiment will be described with reference to FIG. 4. As illustrated in FIG. 4, the video processing system 1 includes a plurality of terminals 100, a center server 200, a base station 300, and a MEC 400. The configuration of each apparatus is exemplary, and another configuration may be used as long as an operation according to the present example embodiment described below can be performed. For example, some functions of the terminal 100 may be disposed in the center server 200 or another apparatus, or some functions of the center server 200 may be disposed in the terminal 100 or another apparatus.

The video processing system 1 is a concrete implementation of a video processing system 10 according to the overview of the example embodiment. The center server 200 is a concrete implementation of the video processing apparatus 20 according to the overview of the example embodiment.

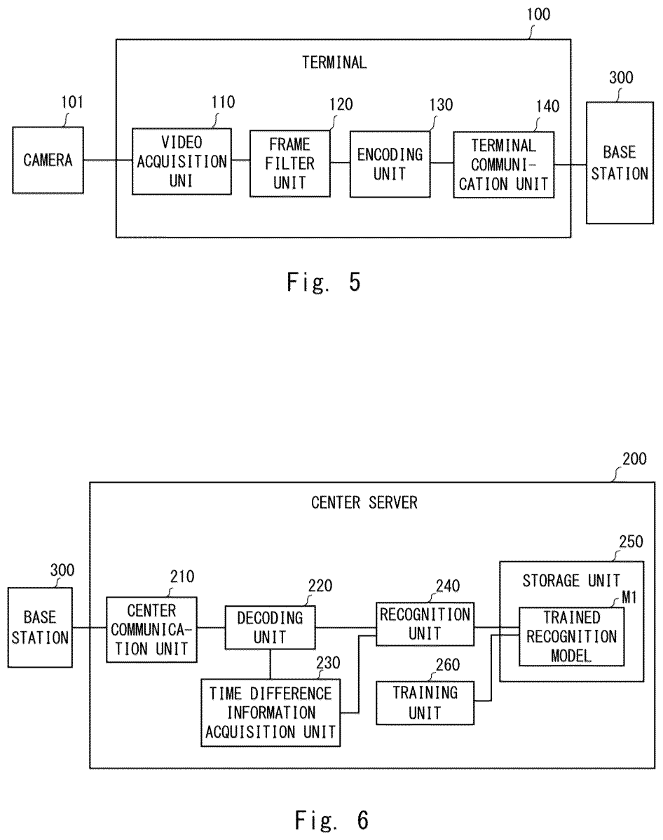

Next, a configuration of the terminal 100 of the video processing system 1 according to the first example embodiment will be described with reference to FIG. 5. FIG. 5 is a block diagram illustrating a configuration of the terminal 100 of the video processing system 1 according to the first example embodiment. As illustrated in FIG. 5, the terminal 100 includes a video acquisition unit 110, a frame filtering unit 120, an encoding unit 130, and a terminal communication unit 140.

The video acquisition unit 110 acquires a video (also referred to as an input video) captured by the camera 101. The input video is, for example, data obtained by imaging a person who is a worker who performs work on a site, a work object used by the person, or the like. The input video includes time-series frames.

The frame filtering unit 120 filters (sorts) the time-series frames included in the input video. The frame filtering unit 120 performs filtering to adjust a bit rate of a video to be transmitted to the center server 200, for example. Here, frames that are not filtered among the frames included in the input video are skipped.

The encoding unit 130 encodes the filtered input video. The encoding unit 130 changes a frame rate of the input video by filtering the frames.

The encoding unit 130 may encode the input video such that a gaze region of the frame has higher image quality than other regions. Specifically, the encoding unit 130 detects an object in the input video using a trained neural network model (for example, a model such as a convolutional neural network), and surrounds the detected object with a box. The encoding unit 130 may enclose the detected object not only in a box but also in a circle, an ellipse, an irregular shape suitable for a silhouette, or the like. Then, the encoding unit 130 recognizes the object inside the box. The encoding unit 130 extracts an object of which a class is a person or a work object from the recognition objects, and determines the inside of the box of the extracted object as a gaze region. The encoding unit 130 encodes the input video such that the gaze region has higher image quality than other regions.

The terminal communication unit 140 transmits the encoded data to the center server 200.

Next, a configuration of the center server 200 of the video processing system 1 according to the first example embodiment will be described with reference to FIG. 6. FIG. 6 is a block diagram illustrating an example of a configuration of the center server 200 of the video processing system 1 according to the first example embodiment. As illustrated in FIG. 6, the center server 200 includes a center communication unit 210, a decoding unit 220, a time difference information acquisition unit 230, a recognition unit 240, a storage unit 250, and a training unit 260.

The center communication unit 210 receives the encoded data transmitted from the terminal 100 via the base station 300. The center communication unit 210 is an interface capable of communicating with the Internet or a core network, and is, for example, a wired interface for IP communication, but may be a wired or wireless interface of any other communication system.

The decoding unit 220 decodes the encoded data received from the terminal 100. The decoding unit 220 corresponds to an encoding system of the terminal 100 and performs decoding in conformity with a moving image encoding system such as H.264 or H.265, for example. The decoding unit 220 decodes each region in the frames according to the compression rate to generate the decoded input video.

The time difference information acquisition unit 230 acquires time difference information ΔT (where ΔT is a natural number) based on time stamp information acquired from a video compression codec or the like. The time difference information ΔT corresponds to a predetermined frame included in the input video and is information indicating a time difference from a previous frame in the predetermined frame. That is, the time difference information ΔT is 1 when the frame is not skipped between the predetermined frame and the previous frame. On the other hand, the time difference information ΔT is 1+n when n frames are skipped between the predetermined frame and the previous frame. The time stamp information is information indicating a timing at which each frame included in the input video is captured by the camera 101. The time stamp information may be information indicating a timing at which each frame is encoded by the encoding unit 130 of the terminal 100.

The recognition unit 240 inputs the time series frames included in the input video and the time difference information ΔT between the frames of the input video as input information to the trained recognition model M1, and recognizes the object in the input video. The recognition unit 240 recognizes, for example, work performed by the worker in the input video, that is, a type of action of the person. Specifically, the trained recognition model M1 is a model of a recurrent neural network (RNN) that inputs time-series frames included in the input video, and includes a plurality of cells of the RNN. The plurality of cells of the RNN input parameters corresponding to the time difference information between the frames of the input video. More specifically, the plurality of cells of the RNN input the parameters in which the time difference information between the frames of the input video is decoded by a decoder.

The storage unit 250 stores the trained recognition model M1.

The training unit 260 generates the trained recognition model M1 by training using the training video, the time difference information ΔT between the frames of the training video, and the correct data.

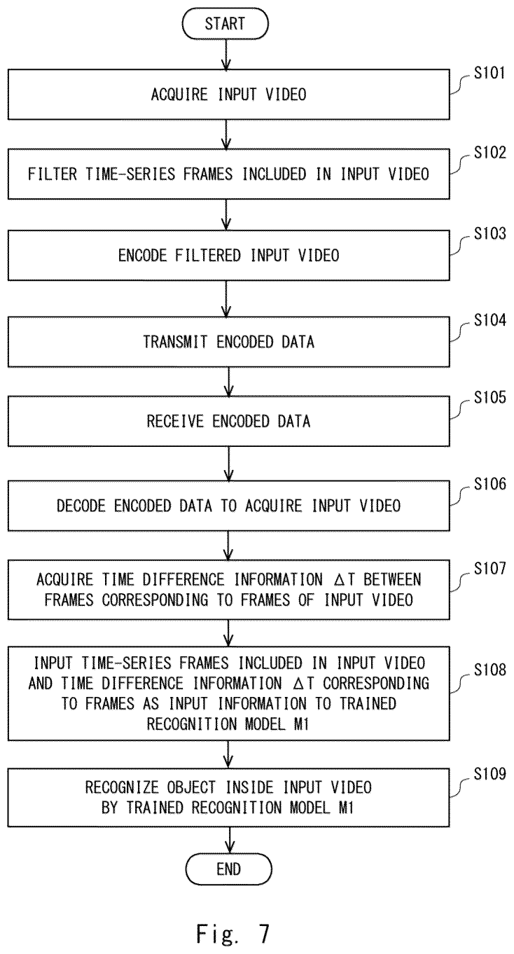

Next, a recognition operation of the video processing system 1 according to the first example embodiment will be described with reference to FIGS. 7 to 9.

FIG. 7 is a flowchart illustrating an operation of the video processing system 1 according to the first example embodiment. As illustrated in FIG. 7, the video acquisition unit 110 of the terminal 100 of the video processing system 1 first acquires an input video obtained by imaging a site from the camera 101 (step S101). The input video includes time-series frames.

The frame filtering unit 120 filters the time-series frames included in the input video (step S102). Here, frames that are not filtered among the frames included in the input video are skipped.

The encoding unit 130 encodes the filtered input video (step S103). Subsequently, the terminal communication unit 140 transmits the encoded data to the center server 200 via the base station 300 (step S104).

Subsequently, the center communication unit 210 of the center server 200 receives the encoded data from the terminal 100 (step S105). Subsequently, the decoding unit 220 decodes the encoded data to acquire the input video (step S106).

Subsequently, the time difference information acquisition unit 230 acquires time difference information ΔT between the frames corresponding to the frames of the input video (step S107). Specifically, the time difference information acquisition unit 230 acquires the time difference information ΔT based on the time stamp information acquired from a video compression codec or the like. The time stamp information is, for example, information regarding a timing at which each frame included in the input video is imaged by the camera 101.

Subsequently, the recognition unit 240 inputs the time-series frames included in the input video and the time difference information ΔT corresponding to the frames of the input video as input information to the trained recognition model M1 (step S108).

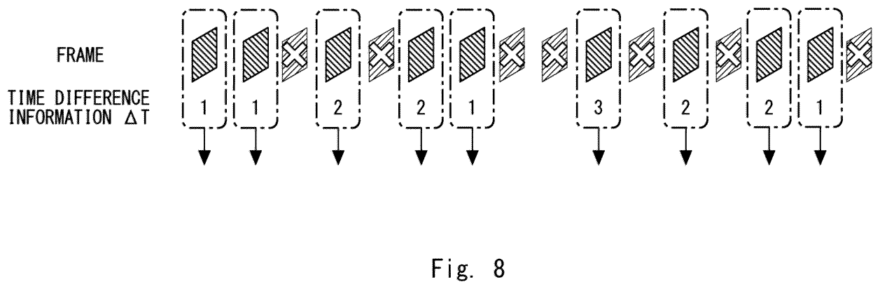

FIG. 8 is a diagram illustrating an example of input information input to the trained recognition model M1. As illustrated in FIG. 8, the input information includes time-series frames included in the input video and the time difference information ΔT corresponding to the frames. The time difference information ΔT indicates a time difference from the previous frame in the corresponding predetermined frame. For example, the time difference information ΔT is 1 when no frame is skipped between the corresponding predetermined frame and the previous frame. The time difference information ΔT is 1+n when n frames are skipped between the corresponding predetermined frame and the previous frame.

The description returns to FIG. 7. Subsequently, the recognition unit 240 recognizes an object in the input video by the trained recognition model M1 (step S109). The recognition unit 240 recognizes, for example, work performed by the worker in the input video, that is, a type of action of the person.

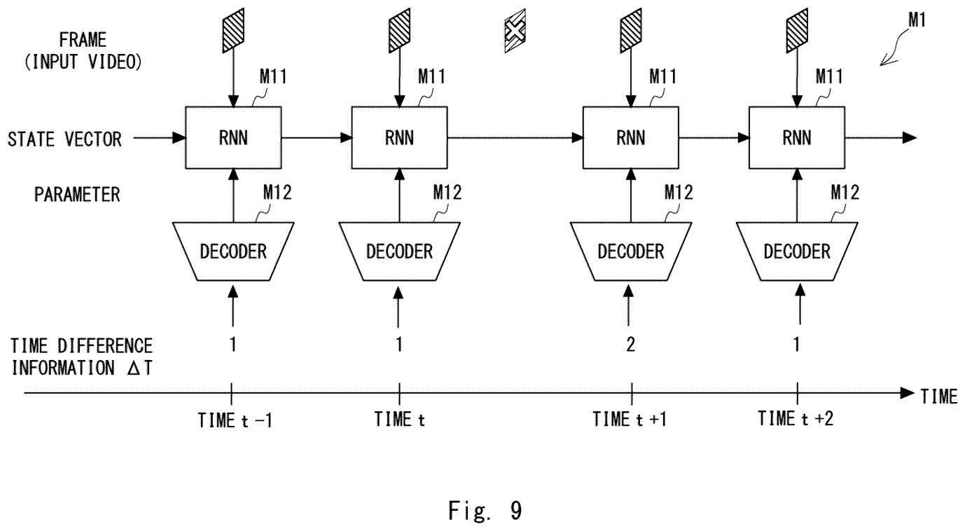

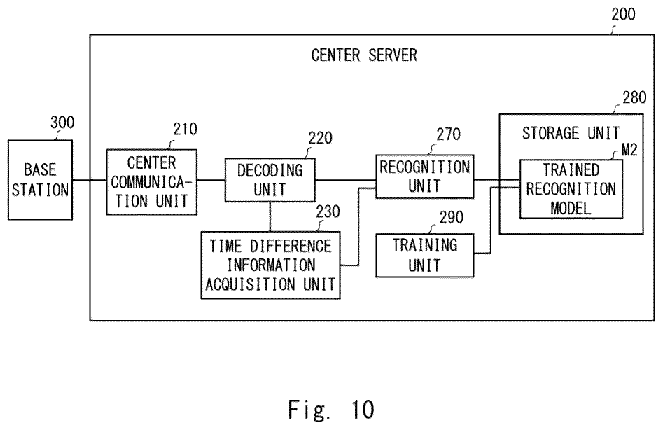

FIG. 9 is a diagram illustrating an example of a configuration and a recognition operation of the trained recognition model M1. As illustrated in FIG. 9, the trained recognition model M1 is a model of a recurrent neural network (RNN) and includes a plurality of cells M11 in a time series of the RNN. When a structure of the RNN is classified into an input layer, an intermediate layer, and an output layer, the cell M11 corresponds to the intermediate layer of the RNN. Further, the trained recognition model M1 includes a decoder M12 corresponding to each cell M11.

At the predetermined time, the decoder M12 receives an input of the time difference information ΔT and outputs a parameter with which the input time difference information ΔT is decoded to the cell M11. Subsequently, the cell M11 receives an input of the frames, a state vector output by the cell M11 at a previous time, and parameter information output by the decoder M12, and outputs the state vector to the cell M11 at a subsequent time. In an initial state of the state vector input to the cell M11, for example, all elements may be 0.

For example, at time t, the decoder M12 receives an input of 1 of the time difference information ΔT and outputs a parameter with which 1 of the time difference information ΔT is decoded to the cell M11. Here, since no frame skipping incurs between a frame input to the cell M11 at time t-1 and a frame input to the cell M11 at time t, the time difference information ΔT input to the decoder M12 at time t is 1. Then, at time t, the cell M11 receives an input of the frames and the state vector and the parameter output by the cell M11 at time t-1, and outputs the state vector to the cell M11 at time t+1.

On the other hand, at time t+1, the decoder M12 receives an input of 2 of the time difference information ΔT, and outputs a parameter with which 2 of the time difference information ΔT is decoded to the cell M11. Here, since skipping of one frame incurs between the frame input to the cell M11 at time t and the frame input to the cell M11 at time t+1, the time difference information ΔT input to the decoder M12 at time t+1 is 2. Then, at time t+1, the cell M11 receives an input of the frames, the state vector, and the parameter output by the cell M11 at time t, and outputs the state vector to the cell M11 at time t+2.

Next, a training operation of the recognition model M1 in the video processing system 1 according to the first example embodiment will be described.

The training unit 260 inputs the time-series frames included in the training video and the time difference information ΔT corresponding to the frames to the recognition model M1. The training video includes, for example, time-series frames in which frame skipping incurs by a predetermined pattern. The configuration of the recognition model M1 has been described above (see FIG. 9). The training unit 260 trains the recognition model M1 by comparing the output result by the recognition model M1 with the correct data, and generates the trained recognition model M1.

As described above, the trained recognition model M1 of the video processing system 1 decodes the time difference information ΔT and dynamically determines the parameter to be input to the cell M11. That is, the trained recognition model M1 can improve the recognition accuracy of the object by reflecting the time difference information of the frames in the recognition of the object in consideration of a case where the frame is skipped due to a change in the frame rate of the video or the like.

### Second Example Embodiment

Next, a configuration of a video processing system 2 according to a second example embodiment will be described. The video processing system 2 includes a plurality of terminals 100, a center server 200, a base station 300, and a MEC 400, similarly to the video processing system 1 according to the first example embodiment. Here, the center server 200 of the video processing system 2 is different from the center server 200 of the video processing system 1 in the following configuration.

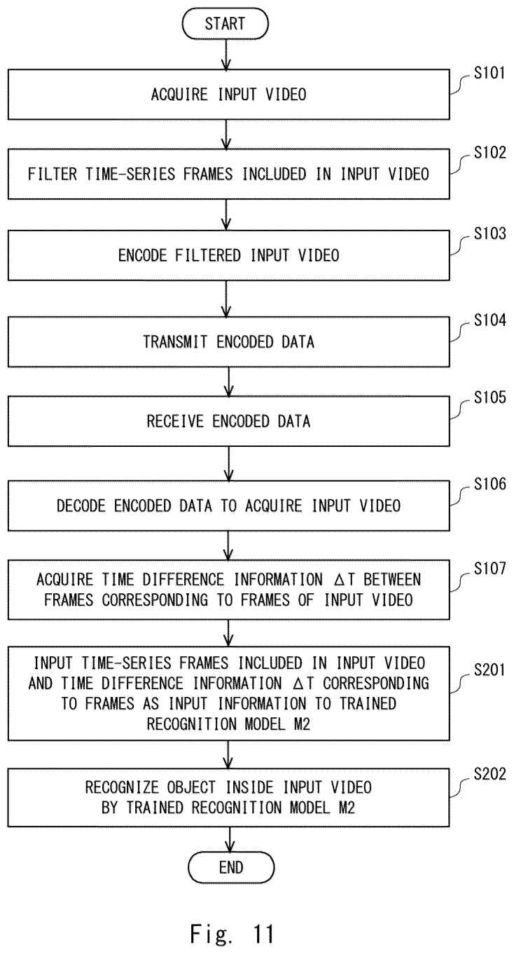

FIG. 10 is a diagram illustrating a configuration of the center server 200 of the video processing system 2. As illustrated in FIG. 10, the center server 200 of the video processing system 2 includes a center communication unit 210, a decoding unit 220, a time difference information acquisition unit 230, a recognition unit 270, a storage unit 280, and a training unit 290.

The recognition unit 270 inputs the time series frames included in the input video and the time difference information ΔT between the frames of the input video as input information to a trained recognition model M2, and recognizes the object in the input video. The trained recognition model M2 includes a plurality of cells of a recurrent neural network (RNN) that inputs time-series frames included in the input video, and inputs and outputs a state vector chronologically. The trained recognition model M2 inserts a state predictor that predicts a state vector based on an inter-frame time difference information ΔT between predetermined cells such as between cells in which frame skipping has incurred.

The storage unit 280 stores the recognition model M2.

The training unit 290 trains the trained recognition model M2 into which the state predictor is inserted using the correct data and the time-series frames in which frame skipping has incurred in a predetermined pattern included in the training video, and the time difference information between the frames of the training video.

The training unit 290 trains a plurality of cells of the trained recognition model M2 using the correct data and the time-series frames which are included in the training video and in which no frame skipping incurs. Then, the training unit 290 inputs the time-series frames which are included in the training video and in which no frame skipping incurs to the plurality of cells of the trained recognition model M2. In this case, the training unit 290 trains the state predictor using the state vector output at time t (where t is a natural number) and the state vector output at time t+N (where N is a natural number) by a plurality of cells.

On the other hand, the recognition unit 270 inputs the input video, the time difference information between the frames of the input video, and a motion between the frames of the input video to the trained recognition model trained using the training video, the time difference information between the frames of the training video, and the motion between the frames of the input video, and recognizes an object in the input video.

The training unit 290 trains the trained recognition model M2 into which the state predictor is inserted using the time difference information between the time-series frames in which the frame skipping incurs in the predetermined pattern included in the training video, the frames of the training video, and the motion between the frames of the input video, and the correct data.

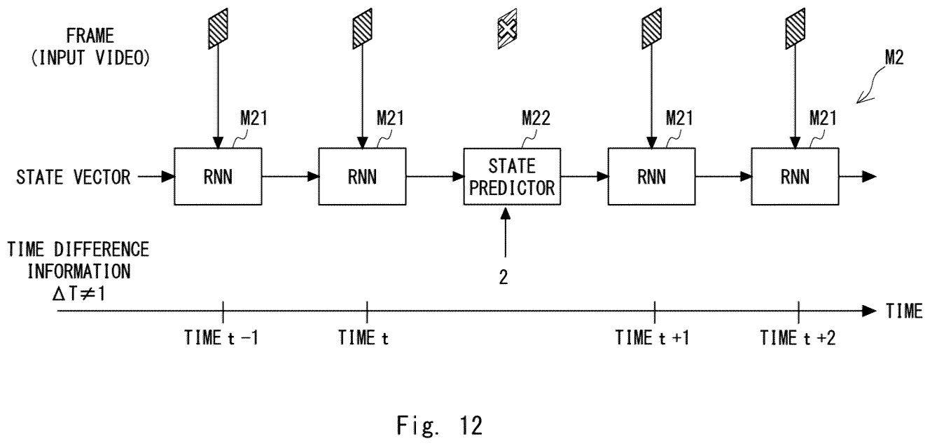

Next, a recognition operation of the video processing system 2 according to the second example embodiment will be described with reference to FIG. 11.

FIG. 11 is a flowchart illustrating an example of an operation of the video processing system 2 according to the second example embodiment. As illustrated in FIG. 11, the video processing system 2 first performs the process of step S101 to the process of step S107 (see FIG. 7) described above. Description of the process of step S101 to the process of step S107 will be omitted.

Subsequently, the recognition unit 270 of the center server 200 inputs the time-series frames included in the input video and the time difference information ΔT corresponding to the frames as input information to the trained recognition model M2 (step S201). An example of the input information has been described above (see FIG. 8). In the present example embodiment, however, the recognition unit 240 sets the time difference information ΔT of ΔT #1 as input information to the trained recognition model M2.

Subsequently, the recognition unit 270 recognizes the object in the input video by the trained recognition model M2 (step S202). The recognition unit 240 recognizes, for example, work performed by the worker in the input video, that is, a type of action of the person.

FIG. 12 is a diagram illustrating an example of a configuration and a recognition operation of the trained recognition model M2 according to the second example embodiment.

As illustrated in FIG. 12, the trained recognition model M2 is a recurrent neural network (RNN) and includes a plurality of cells M21 of a time-series RNN. At a predetermined time, the cell M21 receives an input of the frame and the state vector output by the cell M21 at the previous time, and outputs the state vector to the cell M21 at the subsequent time. In the initial state of the state vector, for example, elements may all be 0.

Further, when frame skipping incurs between a frame input to the cell M21 at a predetermined time and a frame input to the cell M21 at a previous time of the cell M21 at the predetermined time, the trained recognition model M2 inserts the state predictor M22 between the cell M21 at the predetermined time and the cell M21 at the previous time. The incurrence of the frame skipping can be determined from the time difference information ΔT corresponding to the frame input to the cell M21 at the predetermined time. The inserted state predictor M22 receives an input of the state vector output by the cell M21 at the previous time and the time difference information ΔT corresponding to the frame input to the cell M21 at the predetermined time. Then, the state predictor M22 predicts a state vector and outputs the predicted state vector to the cell M21 at the predetermined time.

For example, frame skipping incurs between a frame input to the cell M21 at time t+1 and a frame input to the cell M21 at time t. In this case, the trained recognition model M2 inserts the state predictor M22 between the cell M21 at time t+1 and the cell M21 at time t. The state predictor M22 receives an input of the state vector output by the cell M21 at time t and 2 of the time difference information ΔT corresponding to the frame input to the cell M21 at time t+1. Here, the input time difference information ΔT is 2 since one-frame skipping incurs between the frame input to the cell M21 at time t+1 and the frame input to the cell M21 at time t. The state predictor M22 predicts a state vector and outputs the predicted state vector to the cell M21 at time t+1.

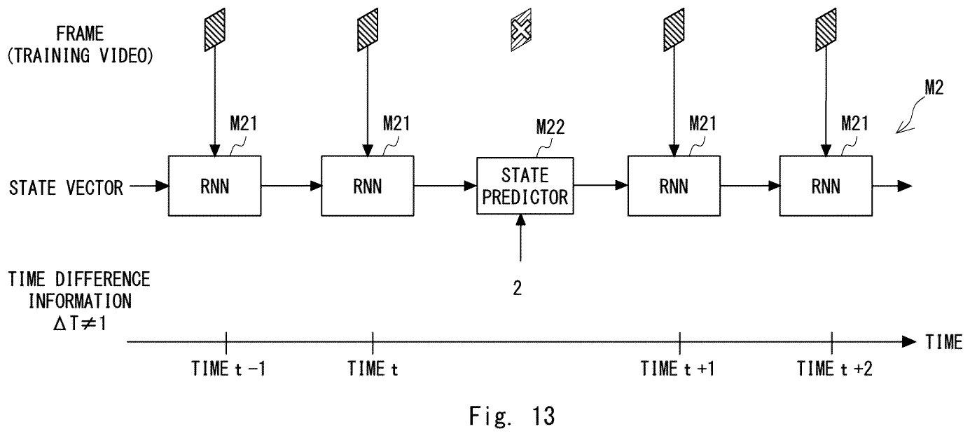

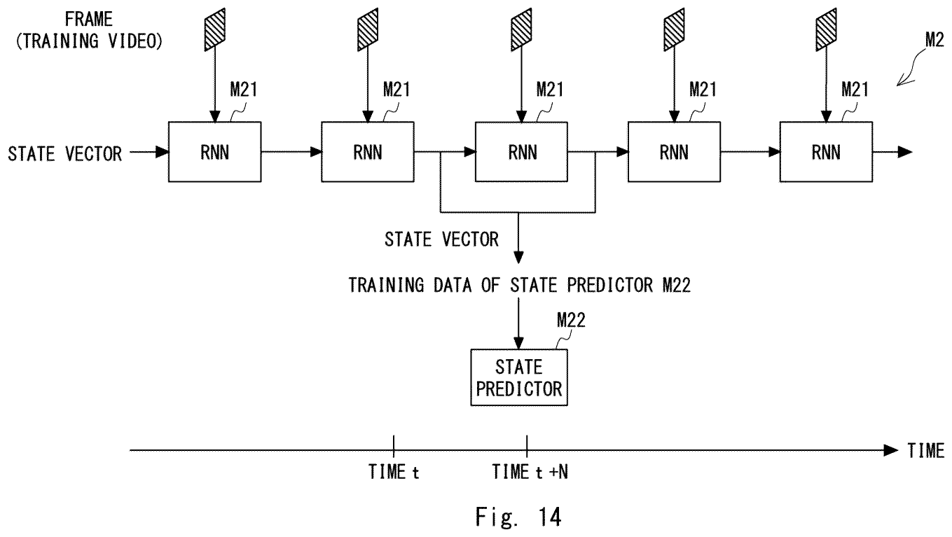

Next, a training operation of the recognition model M2 of the video processing system 2 according to the second example embodiment will be described with reference to FIGS. 13 and 14.

FIG. 13 is a diagram illustrating an example of the first training operation of the recognition model M2.

As illustrated in FIG. 13, the training unit 290 inputs the time-series frames included in the training video and the time difference information ΔT (ΔT #1) corresponding to the frames to the recognition model M2. Specifically, the training unit 290 inputs the time-series frames included in the training video to the plurality of cells M21 of the recognition model M2. In the input time-series frames, the frame skipping incurs by a predetermined pattern. Further, when the frame skipping incurs between a frame input to the cell M21 at the predetermined time of the recognition model M2 and a frame input to the cell M21 at a time previous to the predetermined time, the training unit 290 inserts the state predictor M22 between the cell M21 at the predetermined time and the cell M21 at the previous time. The training unit 290 inputs the time difference information ΔT corresponding to the frame input to the cell M21 at the predetermined time to the state predictor M22. For example, one-frame skipping incurs between the frame input to the predetermined cell M21 at time t+1 and the frame input to the cell M21 at time t. In this case, the training unit 290 inserts the state predictor M22 between the cell M21 at time t+1 and the cell M21 at time t, and inputs 2 of the time difference information ΔT corresponding to the frame input to the predetermined cell M21 at time t+1.

Then, the training unit 290 trains the recognition model M2 into which the state predictor M22 is inserted by comparing an output result by the recognition model M2 into which the state predictor M22 is inserted with the correct data. The training unit 290 may separate the training of the state predictor M22 from the training of the recognition model M2.

FIG. 14 is a diagram illustrating an example of the second training operation of the recognition model M2.

As illustrated in FIG. 14, the training unit 290 inputs the time-series frames included in the training video to the plurality of cells M21 of the recognition model M2. In the input time-series frames, the frame skipping does not incur. Then, the training unit 290 trains the recognition model M2 by comparing the output result by the recognition model M2 with the correct data.

Subsequently, the training unit 290 inputs the time-series frames included in the training video to the plurality of cells M21 of the trained recognition model M2. In the input time-series frames, the frame skipping does not incur.

Subsequently, the training unit 290 acquires a data set including the state vector output from the cell M21 at time t and the state vector output from the cell M21 at time t+N (where N is a natural number), and trains the state predictor M22 using the acquired data set as training data. Specifically, the training unit 290 trains the state predictor M22 by performing regression analysis so that the output result at the time of inputting of the state vector at time t and N to the state predictor M22 approaches a state vector at time t+N.

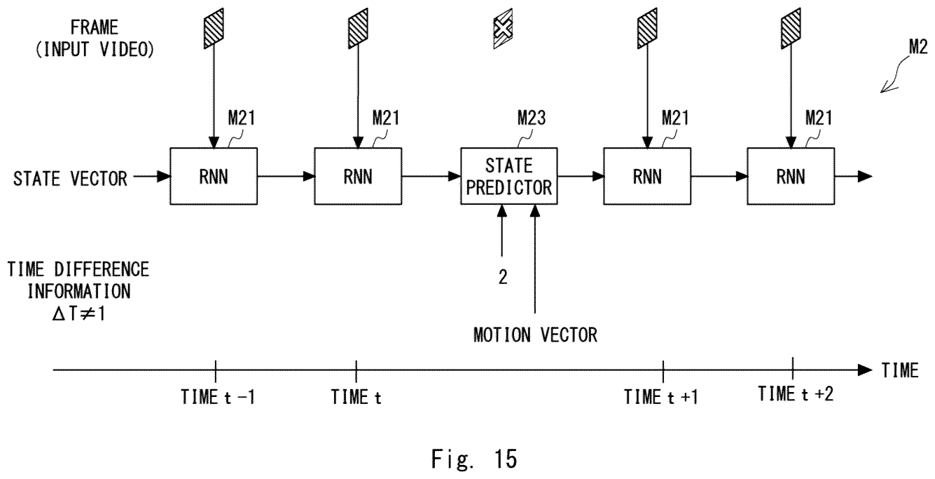

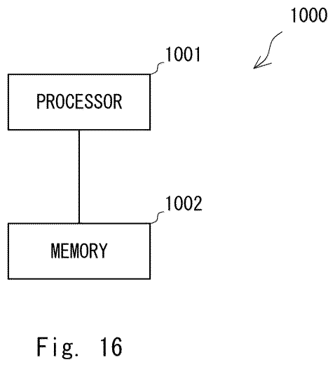

FIG. 15 is a diagram illustrating another example of the recognition operation of the trained recognition model M2 according to the second example embodiment.

As illustrated in FIG. 15, the trained recognition model M2 is a recurrent neural network (RNN) and includes the plurality of cells M21 of the time-series RNN. At a predetermined time, the cell M21 receives an input of the frame and the state vector output by the cell M21 at the previous time, and outputs the state vector to the cell M21 at the subsequent time. In the initial state of the state vector, for example, elements may all be 0.

Further, when the frame skipping incurs between the frame input to the cell M21 at the predetermined time and the frame input to the cell M21 at the previous time of the cell M21 at the predetermined time, the trained recognition model M2 inserts a state predictor M23 between the predetermined cell M21 and the cell M21 at the previous time. The state predictor M23 receives an input of the state vector output by the cell M21 at the previous time, the time difference information ΔT corresponding to the frame input to the cell M21 at the predetermined time, and a motion vector. The motion vector is information obtained by vectorizing a difference between the frame at the predetermined time and the frame at the previous time, that is, a motion. The state predictor M23 predicts a state vector and outputs the predicted state vector to the cell M21 at the predetermined time.

For example, frame skipping incurs between a frame input to the cell M21 at time t+1 and a frame input to the cell M21 at time t. In this case, the trained recognition model M2 inserts the state predictor M23 between the cell M21 at time t+1 and the cell M21 at time t. The state predictor M23 receives an input of the motion vector together with the state vector output by the cell M21 at time t and 2 of the time difference information ΔT corresponding to the frame input to the cell M21 at time t+1. The input motion vector indicates a difference between the frame input to the cell M21 at time t and the frame input to the cell M21 at time t+1, that is, a motion. The state predictor M23 predicts a state vector and outputs the predicted state vector to the cell M21 at time t+1.

Next, a training operation of the recognition model M2 in the video processing system 2 will be described.

The training unit 290 inputs the time-series frames included in the training video, the time difference information ΔT (ΔT #1) corresponding to the frames, and the motion vector to the recognition model M2. The training unit 290 trains the recognition model M2 into which the state predictor M22 is inserted by comparing an output result of the recognition model M2 into which the state predictor M22 is inserted with the correct data. The training unit 290 may separate the training of the state predictor M22 from the training of the recognition model M2.

As described above, when the frame skipping incurs, the trained recognition model M2 of the video processing system 2 according to the second example embodiment inserts the state predictor M22 or the state predictor M23 between the cells M21 and predicts the state vector. The trained recognition model M1 can improve the recognition accuracy of the object by reflecting the time difference information of the frame in the recognition of the object in consideration of a case where the frame is skipped due to a change in the frame rate of the video or the like.

Each configuration in the above-described example embodiments may be implemented by hardware, software, or both, and may be implemented by one piece of hardware or software or by a plurality of pieces of hardware or software. Each apparatus and each function (processing) may be realized by a computer 1000 including a processor 1001 such as a central processing unit (CPU) and a memory 1002 which is a storage device as illustrated in FIG. 19. For example, a program that performs the method (video processing method) in the example embodiment may be stored in the memory 1002, and each function may be realized by the processor 1001 executing the program stored in the memory 1002.

The program includes a group of instructions (or software codes) causing a computer to perform one or more of the functions described in the example embodiments when the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, transitory computer-readable or communication media include electrical, optical, and acoustic propagated signals or other forms of propagated signals.

Some or all of the above-described example embodiments may be described as in the following Supplementary Notes, but are not limited to the following Supplementary Notes.

### (Supplementary Note 1)

A video processing system including:
video acquisition means for acquiring an input video;
time difference information acquisition means for acquiring first time difference information between frames of the input video; and
recognition means for inputting the input video and the first time difference information between the frames of the input video to a trained recognition model trained using a training video and second time difference information between frames of the training video and recognizing an object in the input video.

### (Supplementary Note 2)

The video processing system according to Supplementary Note 1, wherein
the trained recognition model is a model including a plurality of cells of a recurrent neural network (RNN) that inputs time-series frames included in the input video, and
the plurality of cells input a parameter corresponding to first time difference information between the frames of the input video.

### (Supplementary Note 3)

The video processing system according to Supplementary Note 2, wherein the plurality of cells input a parameter obtained by decoding the first time difference information between the frames of the input video.

### (Supplementary Note 4)

The video processing system according to Supplementary Note 1, wherein
the trained recognition model includes a plurality of cells of a recurrent neural network that inputs time-series frames included in the input video, and inputs and outputs state vectors chronologically, and
a state predictor that predicts the state vectors based on the first time difference information between the frames of the input video is inserted between predetermined cells.

### (Supplementary Note 5)

The video processing system according to Supplementary Note 4, wherein the trained recognition model into which the state predictor is inserted is trained using time-series frames in which frame skipping incurs in a predetermined pattern included in the training video, the second time difference information between the frames of the training video, and correct data.

### (Supplementary Note 6)

The video processing system according to Supplementary Note 4, wherein
the plurality of cells of the trained recognition model are trained using time-series frames which are included in the training video and in which no frame skipping incurs and correct data, and
the state predictor inserted into the trained recognition model is trained using a state vector output at time t (where t is natural number) and a state vector output at time t+N (where N is a natural number) by the plurality of cells when time-series frames which are included in the training video and in which no frame skipping incurs are input to the plurality of trained cells.

### (Supplementary Note 7)

The video processing system according to Supplementary Note 1, wherein the recognition means inputs the input video, the first time difference information between the frames of the input video, and a motion between frames of the input video to a trained recognition model trained by using the training video, the second time difference information between the frames of the training video, and the motion between the frames of the training video, and recognizes an object in the input video.

### (Supplementary Note 8)

A video processing apparatus including:
video acquisition means for acquiring an input video;
time difference information acquisition means for acquiring first time difference information between frames of the input video; and
recognition means for inputting the input video and the first time difference information between the frames of the input video to a trained recognition model trained using a training video and second time difference information between frames of the training video and recognizing an object in the input video.

### (Supplementary Note 9)

The video processing apparatus according to Supplementary Note 8, wherein
the trained recognition model is a model including a plurality of cells of a recurrent neural network (RNN) that inputs time-series frames included in the input video, and
the plurality of cells input a parameter corresponding to first time difference information between the frames of the input video.

### (Supplementary Note 10)

The video processing apparatus according to Supplementary Note 9, wherein the plurality of cells input a parameter obtained by decoding the first time difference information between the frames of the input video.

### (Supplementary Note 11)

The video processing apparatus according to Supplementary Note 8, wherein
the trained recognition model includes a plurality of cells of a recurrent neural network that inputs time-series frames included in the input video, and inputs and outputs state vectors chronologically, and
a state predictor that predicts the state vectors based on the first time difference information between the frames of the input video is inserted between predetermined cells.

### (Supplementary Note 12)

The video processing apparatus according to Supplementary Note 11, wherein the trained recognition model into which the state predictor is inserted is trained using time-series frames in which frame skipping incurs in a predetermined pattern included in the training video, the second time difference information between the frames of the training video, and correct data.

### (Supplementary Note 13)

The video processing apparatus according to Supplementary Note 11, wherein
the plurality of cells of the trained recognition model are trained using time-series frames which are included in the training video and in which no frame skipping incurs and correct data, and
the state predictor inserted into the trained recognition model is trained using a state vector output at time t (where t is natural number) and a state vector output at time t+N (where N is a natural number) by the plurality of cells when time-series frames which are included in the training video and in which no frame skipping incurs are input to the plurality of trained cells.

### (Supplementary Note 14)

The video processing apparatus according to Supplementary Note 8, wherein the recognition means inputs the input video, the first time difference information between the frames of the input video, and a motion between frames of the input video to a trained recognition model trained by using the training video, the second time difference information between the frames of the training video, and the motion between the frames of the training video, and recognizes an object in the input video.

### (Supplementary Note 15)

A video processing method comprising: by a computer,
acquiring an input video;
acquiring first time difference information between frames of the input video; and
inputting the input video and the first time difference information between the frames of the input video to a trained recognition model trained using a training video and second time difference information between frames of the training video and recognizing an object in the input video.

### (Supplementary Note 16)

The video processing method according to Supplementary Note 15, wherein
the trained recognition model is a model including a plurality of cells of a recurrent neural network (RNN) that inputs time-series frames included in the input video, and
the plurality of cells input a parameter corresponding to first time difference information between the frames of the input video.

### (Supplementary Note 17)

The video processing method according to Supplementary Note 16, wherein the plurality of cells input a parameter obtained by decoding the first time difference information between the frames of the input video.

### (Supplementary Note 18)

The video processing method according to Supplementary Note 15, wherein
the trained recognition model includes a plurality of cells of a recurrent neural network that inputs time-series frames included in the input video, and inputs and outputs state vectors chronologically, and
a state predictor that predicts the state vectors based on the first time difference information between the frames of the input video is inserted between predetermined cells.

### (Supplementary Note 19)

The video processing method according to Supplementary Note 18, wherein the trained recognition model into which the state predictor is inserted is trained using time-series frames in which frame skipping incurs in a predetermined pattern included in the training video, the second time difference information between the frames of the training video, and correct data.

### (Supplementary Note 20)

The video processing method according to Supplementary Note 18, wherein
the plurality of cells of the trained recognition model are trained using time-series frames which are included in the training video and in which no frame skipping incurs and correct data, and
the state predictor inserted into the trained recognition model is trained using a state vector output at time t (where t is natural number) and a state vector output at time t+N (where N is a natural number) by the plurality of cells when time-series frames which are included in the training video and in which no frame skipping incurs are input to the plurality of trained cells.

### (Supplementary Note 21)

The video processing method according to Supplementary Note 15, wherein the computer inputs the input video, the first time difference information between the frames of the input video, and a motion between frames of the input video to a trained recognition model trained by using the training video, the second time difference information between the frames of the training video, and the motion between the frames of the training video, and recognizes an object in the input video.

### REFERENCE SIGNS LIST

1, 2, 10 VIDEO PROCESSING SYSTEM
11 VIDEO ACQUISITION UNIT
12 TIME DIFFERENCE INFORMATION ACQUISITION UNIT
13 RECOGNITION UNIT
20 VIDEO PROCESSING APPARATUS
100 TERMINAL
101 CAMERA
102 COMPRESSION EFFICIENCY OPTIMIZATION FUNCTION
110 VIDEO ACQUISITION UNIT
120 FRAME FILTER UNIT
130 ENCODING UNIT
140 TERMINAL COMMUNICATION UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 CENTER COMMUNICATION UNIT
220 DECODING UNIT
230 TIME DIFFERENCE INFORMATION ACQUISITION UNIT
240, 270 RECOGNITION UNIT
250, 280 STORAGE UNIT
260, 290 TRAINING UNIT
300 BASE STATION
401 COMPRESSION BIT RATE CONTROL FUNCTION
1000 COMPUTER
1001 PROCESSOR
1002 MEMORY
M1, M2 RECOGNITION MODEL
M11, M21 CELL
M12 DECODER
M22, M23 STATE PREDICTOR

What is claimed is:

1. A video processing system comprising:
at least one memory storing instructions, and
at least one processor configured to execute the instructions to:
acquire an input video;
acquire first time difference information between frames of the input video; and
input the input video and the first time difference information between the frames of the input video to a trained recognition model trained using a training video and second time difference information between frames of the training video and recognizing an object in the input video.

2. The video processing system according to claim 1, wherein
the trained recognition model is a model including a plurality of cells of a recurrent neural network (RNN) that inputs time-series frames included in the input video, and
the plurality of cells input a parameter corresponding to first time difference information between the frames of the input video.

3. The video processing system according to claim 1, wherein
the trained recognition model includes a plurality of cells of a recurrent neural network that input time-series frames included in the input video, and input and output state vectors chronologically, and
a state predictor that predicts the state vectors based on the first time difference information between the frames of the input video is inserted between predetermined cells.

4. The video processing system according to claim 3, wherein the trained recognition model into which the state predictor is inserted is trained using time-series frames in which frame skipping incurs in a predetermined pattern included in the training video, the second time difference information between the frames of the training video, and correct data.

5. The video processing system according to claim 3, wherein
the plurality of cells of the trained recognition model are trained using time-series frames which are included in the training video and in which no frame skipping incurs and correct data, and
the state predictor inserted into the trained recognition model is trained using a state vector output at time t (where t is natural number) and a state vector output at time t+N (where N is a natural number) by the plurality of cells when time-series frames which are included in the training video and in which no frame skipping incurs are input to the plurality of trained cells.

6. The video processing system according to claim 1, wherein the recognition means inputs the input video, the first time difference information between the frames of the input video, and a motion between frames of the input video to a trained recognition model trained by using the training video, the second time difference information between the frames of the training video, and the motion between the frames of the training video, and recognizes an object in the input video.

7. A video processing apparatus comprising:
at least one memory storing instructions, and
at least one processor configured to execute the instructions to:
acquire an input video;
acquire first time difference information between frames of the input video; and
input video and the first time difference information between the frames of the input video to a trained recognition model trained using a training video and second time difference information between frames of the training video and recognizing an object in the input video.

8. The video processing apparatus according to claim 7, wherein
the trained recognition model is a model including a plurality of cells of a recurrent neural network (RNN) that inputs time-series frames included in the input video, and
the plurality of cells input a parameter corresponding to first time difference information between the frames of the input video.

9. The video processing apparatus according to claim 7, wherein
the trained recognition model includes a plurality of cells of a recurrent neural network that input time-series frames included in the input video, and input and output state vectors chronologically, and
a state predictor that predicts the state vectors based on the first time difference information between the frames of the input video is inserted between predetermined cells.

10. The video processing apparatus according to claim 9, wherein the trained recognition model into which the state predictor is inserted is trained using time-series frames in which frame skipping incurs in a predetermined pattern included in the training video, the second time difference information between the frames of the training video, and correct data.

11. The video processing apparatus according to claim 9, wherein
the plurality of cells of the trained recognition model are trained using time-series frames which are included in the training video and in which no frame skipping incurs and correct data, and
the state predictor inserted into the trained recognition model is trained using a state vector output at time t (where t is natural number) and a state vector output at time t+N (where N is a natural number) by the plurality of cells when time-series frames which are included in the training video and in which no frame skipping incurs are input to the plurality of trained cells.

12. The video processing apparatus according to claim 7, wherein the recognition means inputs the input video, the first time difference information between the frames of the input video, and a motion between frames of the input video to a trained recognition model trained by using the training video, the second time difference information between the frames of the training video, and the motion between the frames of the training video, and recognizes an object in the input video.

13. A video processing method comprising: by a computer,
acquiring an input video;
acquiring first time difference information between frames of the input video; and
inputting the input video and the first time difference information between the frames of the input video to a trained recognition model trained using a training video and second time difference information between frames of the training video and recognizing an object in the input video.

14. The video processing method according to claim 13, wherein
the trained recognition model is a model including a plurality of cells of a recurrent neural network (RNN) that inputs time-series frames included in the input video, and
the plurality of cells input a parameter corresponding to first time difference information between the frames of the input video.

15. The video processing method according to claim 13, wherein
the trained recognition model includes a plurality of cells of a recurrent neural network that input time-series frames included in the input video, and input and output state vectors chronologically, and
a state predictor that predicts the state vectors based on the first time difference information between the frames of the input video is inserted between predetermined cells.

16. The video processing method according to claim 15, wherein the trained recognition model into which the state predictor is inserted is trained using time-series frames in which frame skipping incurs in a predetermined pattern included in the training video, the second time difference information between the frames of the training video, and correct data.

17. The video processing method according to claim 15, wherein
the plurality of cells of the trained recognition model are trained using time-series frames which are included in the training video and in which no frame skipping incurs and correct data, and
the state predictor inserted into the trained recognition model is trained using a state vector output at time t (where t is natural number) and a state vector output at time t+N (where N is a natural number) by the plurality of cells when time-series frames which are included in the training video and in which no frame skipping incurs are input to the plurality of trained cells.

18. The video processing method according to claim 13, wherein the computer inputs the input video, the first time difference information between the frames of the input video, and a motion between frames of the input video to a trained recognition model trained by using the training video, the second time difference information between the frames of the training video, and the motion between the frames of the training video, and recognizes an object in the input video.
